(19) United States
(12) Patent Application Publication
(10) Pub. No.: US 2014/0350837 A1
(43) Pub. Date: Nov. 27, 2014

(54) Method for an automatic intervention into an ego vehicle when traveling erroneously, in particular when traveling the wrong way

(71) Applicants: Roland GALBAS, Ludwigsburg (DE); Volker HOFSAESS, Moeglingen (DE)

(72) Inventors: Roland GALBAS, Ludwigsburg (DE); Volker HOFSAESS, Moeglingen (DE)

(73) Assignee: Robert Bosch GmbH, Stuttgart (DE)

(21) Appl. No.: 14/280,256

(22) Filed: May 16, 2014

(30) Foreign Application Priority Data
May 22, 2013 (DE) 10 2013 209 502.3

(51) Int. Cl. B60W 30/09

(52) U.S. Cl. CPC B60W 30/09
USPC 701/301

(57) ABSTRACT

A method for an automatic intervention into an ego vehicle when it is traveling erroneously, in particular when it is traveling the wrong way, on a road, via a safety device or a safety system of the ego vehicle, the wrong-way travel of the ego vehicle on the road initially being detected, and automated backward travel being able to be carried out by the ego vehicle chronologically after the detection of the wrong-way travel. Furthermore, the invention relates to a computer program product which is configured to carry out an intervention method according to the present invention; a computing unit or a processing device, which may be a control unit or a control device for a vehicle; and a safety device or a safety system for a vehicle, in particular a driver assistance system for a motor vehicle.

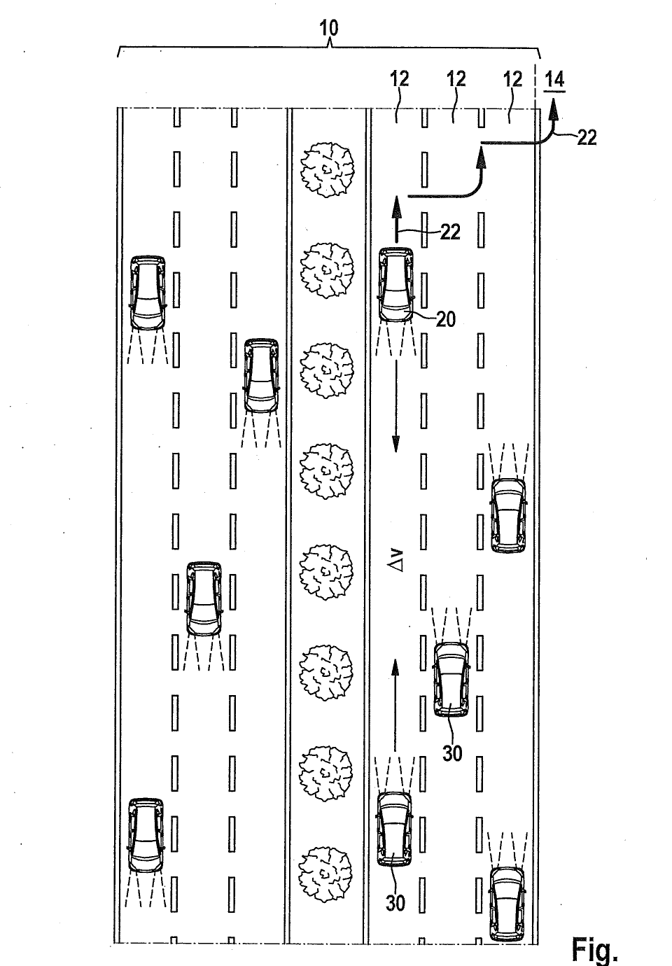

### RELATED APPLICATION INFORMATION

The present application claims priority to and the benefit of German patent application no. 10 2013 209 502.3, which was filed in Germany on May 22, 2013, the disclosure of which is incorporated herein by reference.

### FIELD OF THE INVENTION

The present invention relates to a method for an automatic intervention into an ego vehicle when it is traveling erroneously, in particular, when it is traveling the wrong way, on a road, via a safety device or a safety system of the ego vehicle. Furthermore, the present invention relates to a computer program product which is configured to carry out an intervention method according to the present invention; a computing unit or a processing device, which may be a control unit or a control device for a vehicle; and a safety device or a safety system for a vehicle, in particular a driver assistance system for a motor vehicle.

### BACKGROUND INFORMATION

Active safety is one of the key aspects in the development of both present and future motor vehicle systems. Known safety or driver assistance systems in the field of active safety of motor vehicle occupants, i.e., for accident prevention of the relevant vehicle, are, for example, EPS (electronic power steering) having automatic steering intervention, ESC (electronic stability control) for stabilizing the motor vehicle using brake interventions within the limit range of vehicle dynamics, and VDM (vehicle dynamic management) as an enhancement of ESC using additional automated steering interventions.

The phenomenon of so-called “ghost driving,” i.e., a motor vehicle traveling the wrong way, for example, on a freeway having separated roadways and multiple lanes per roadway, is gaining popular awareness and is becoming increasingly important. Because of the high relative speeds of the involved motor vehicles, wrong-way travel often results in particularly severe accidents (head-on collisions), the probabilities of which increase with a total duration of the wrong-way travel of the motor vehicle. In addition, oncoming motor vehicles, i.e., vehicle drivers of other vehicles who are traveling correctly, are unprepared. An identification or detection of wrong-way travel of the host vehicle, referred to as an “ego vehicle” below, is therefore of particular importance.

The wrong-way travel is detected based on map-based navigation of the ego vehicle (GPS (global positioning system) and map information), for which additional information with respect to the road category, direction identification, and traffic control signs are integrated into the map information. Furthermore, video-based information or another type of information is available to the motor vehicle for this purpose, for example, surroundings detection (surroundings sensors), detection of a road category (road class), traffic sign identification, etc.—After erroneously entering or approaching a road having separated roadways (separated lane directions), such as freeways, federal highways, or ramps to them (road category, possibly other roads in a foreign country), changing a direction of travel is difficult.

After the ego vehicle has erroneously entered a relevant driving path, a manual turning of the ego vehicle is associated with a high accident risk due to the oncoming vehicles. Backward travel which is steered by a vehicle driver of the ego vehicle is possible only at great risk to the wrong-way driver, i.e., the ego vehicle, due to the vehicle driver's looking away from the oncoming vehicles. In addition, the vehicle driver of the ego vehicle is under the effects of extreme stress. —Depending on the volume of traffic, immediately after entering the roadway the wrong way, the vehicle driver of the ego vehicle may have very few options for averting an accident.

### SUMMARY OF THE INVENTION

It is therefore one object of the present invention to provide a method which enables a vehicle driver of an ego vehicle to lower an accident risk after wrong-way entry onto a roadway. The method according to the present invention is to be able to operate together with an existing wrong-way travel assistant or the like, in order to increase its effectiveness. The method according to the present invention is to operate safely and reliably and is to be cost-effective to implement. The method is to be implementable using a sensor system and/or actuator system which is already installed in a motor vehicle. Furthermore, in accordance with this method, one object of the present invention is to provide a computer program, a computing unit or a processing device, and a safety device or a safety system for the ego vehicle.

The object of the present invention may be achieved using a method for an automatic intervention into an ego vehicle when traveling erroneously, in particular, when traveling the wrong way, on a road, via a safety device or a safety system of the ego vehicle, as described herein; with the aid of a computer program product as described herein; with the aid of a computing unit or a processing device, which may be a control unit or a control device for a vehicle, as described herein;

and with the aid of a safety device or a safety system for a vehicle, in particular a driver assistance system for a motor vehicle, as described herein. Advantageous refinements, additional features, and/or advantages of the present invention result from the description herein and the following description.

In the method according to the present invention for an automatic intervention into an ego vehicle which may be moving when traveling the wrong way, wrong-way travel of the ego vehicle on the road is initially ascertained, detected, or identified, in which the ego vehicle is to be placed into a comparatively safe location in a forward/rear evasion area on/next to the road essentially automatically, i.e., essentially independently, by the ego vehicle during the wrong-way travel. The actual intervention (see below) into the ego vehicle may assume the following or may be determined as follows: positive detection/identification of a road category of the road or a road having relevance to wrong-way travel, positive detection/identification of the wrong-way travel of the ego vehicle on this road, and if necessary, positive detection/identification of the forward/rear evasion area for the ego vehicle.—The positive detection/identification of the road category means: traveling into or traveling in a lane which is delimited structurally and/or by markings, or traveling into or traveling in one lane among a plurality of lanes which are delimited structurally and/or by markings in only one single direction of travel.

The optional identification of the evasion area for the ego vehicle may be carried out by a search for a forward/rear evasion area and/or a forward/rear escape point or area, an intervention having a low hazard potential for another vehicle and/or the ego vehicle may be selected. Thus, for example, a surroundings sensor system of the ego vehicle, in particular, a video, radar, and/or other sensor system, may analyze and pick the evasion area and/or the escape point or area working together with a navigation device.—The identification of the road category and the wrong-way travel, or the detection of the travel in the lane(s) which are delimited structurally and/or by markings in only one direction of travel, may likewise be carried out with the aid of this sensor system, in which a traffic sign identification may furthermore be used.

According to the present invention, for the intervention, the safety device or the safety system of the ego vehicle may determine a trajectory, in particular traveling within a lane, or an evasion trajectory, in particular traveling across a marking of the traveled lane. The navigation device, may, for example, calculate a distance to the nearest forward/rear evasion area. The safety device or the safety system of the ego vehicle may then ascertain the trajectory and/or evasion trajectory.—The intervention into the ego vehicle may include at least one automated steering, brake, and/or acceleration intervention, the ego vehicle carrying out forward travel or backward travel in an automated manner and if necessary, performing an evasive maneuver. Thus, in this actual vehicle intervention, the ego vehicle is moved linearly and/or rotationally to the forward/rear evasion area via automated steering, braking, and/or positive or negative acceleration.

According to the present invention, a situation evaluation is carried out for the ego vehicle chronologically before carrying out the actual vehicle intervention, i.e., the automated forward exit or automated backward travel according to the present invention, if necessary, including the automated evasive maneuver, via the safety device or the safety system, an intervention having a low hazard potential being selected. A low hazard potential means that there is a low or what may be a lowest hazard potential for a vehicle driver and/or another occupant of the ego vehicle or the ego vehicle itself, and/or an occupant of another vehicle or the other vehicle itself, and/or a third road user. Any combinations thereof may be evaluated and selected in a hazard potential analysis. Based on this analysis, the method may be carried out.

If a forward exit having a low hazard potential is possible, then this option is selected according to the present invention. A forward evasion area or a forward open area or a forward escape point for the forward exit may be an emergency lane, a shoulder, a turnout, a median, a dividing strip, a guard rail gap, a hard shoulder, an embankment, a parking bay, a parking lot, a rest stop, a gas station, an entry ramp, possibly for emergency vehicles, an exit ramp, and/or an area of the road moving with the ego vehicle traveling the wrong way, etc. At least the section of this evasion area must be free from another vehicle at the point in time at which the ego vehicle carries out a part of its forward exit and/or an evasive maneuver there. The forward exit and/or the evasive maneuver may be carried out in an automated or semi-automated manner.

If a forward exit having a low hazard potential is not possible, i.e., for example, the ego vehicle drives directly into oncoming traffic, then automated backward travel is able to be carried out by the ego vehicle according to the present invention. The automated backward travel may be initiated and carried out by the safety device or the safety system of the ego vehicle. The safety device or the safety system of the ego vehicle determines a trajectory and/or an evasion trajectory for the backward travel, possibly to a rear evasion area, a rear open area, and/or a rear escape point. According to the present invention, the backward travel is carried out essentially at a maximum speed, the hazard warning lights and/or possibly other visual and/or audible warning signals (for example, a flashing high beam) of the ego vehicle may be active. Chronologically after the backward travel, a request for assuming control of the vehicle and/or for accelerating the ego vehicle may be issued to the vehicle driver of the ego vehicle.

The rear evasion area or the rear open area or the rear escape point for the backward travel of the ego vehicle may, similarly to above, be a rearward emergency lane, a rearward shoulder, a rearward turnout, a rearward median, a rearward dividing strip, a rearward guard rail gap, a rearward hard shoulder, a rearward embankment, a rearward parking bay, a rearward parking lot, a rearward rest stop, a rearward gas station, a rearward entry ramp, possibly for emergency vehicles, a rearward exit ramp, and/or a rearward area of the road moving with the ego vehicle traveling the wrong way, etc. At least that section of this rearward evasion area must be free of another vehicle at that point in time at which the ego vehicle carries out a section of its backward travel, a lane change, and/or an evasive maneuver there.

The intervention may include at least one brake, acceleration, and/or steering intervention into the ego vehicle, the ego vehicle may brake in an automated manner, initiating and carrying out the backward travel in an automated manner, and if necessary, when braking and/or during the backward travel, carrying out a lane change in an automated manner and/or an evasive maneuver in an automated manner.—The automatic or automated backward travel of the ego vehicle may, for example, be carried out based on a front driving camera, a rear driving camera, LIDAR (light detection and ranging, method for optical distance and speed measurement), a ToF sensor system (time-of-flight sensor, sensor for measuring the travel time of light), and/or based on additional surroundings sensors such as radar, etc. This may be supported by map-based navigation.—The backward travel may also be carried out based on only a front camera, the trajectory or the evasion trajectory being estimated from a course of a roadway marking of the road which is traveled on. Backward travel (trajectory and/or evasion trajectory) to the emergency lane or the like may likewise be carried out based on the roadway marking. Such a roadway marking may be an emergency lane.

If no front camera or front sensor system exists, the vehicle driver himself/herself may indicate the option of changing the lane (no oncoming traffic in the lane to be changed) to the safety device or to the safety system, for example, by a comparatively short turning of the steering wheel of his/her vehicle, or the like. In the method according to the present invention, a condition of the vehicle driver may be evaluated and included, for example, based on an item of information from the vehicle driver for the automated intervention (see above, other options are of course applicable) and/or based on an interior sensor system. Furthermore, subordinate devices and road users, in particular, other vehicles located in the vicinity or their vehicle drivers, may be informed about the actual intervention or the planned, actual intervention, i.e., the backward travel.

The automated backward travel may include at least one lane change to the rear evasion area, in particular to an emergency lane or a safe route or a safe area, additional automated backward travel up to a safe position which may be able to be carried out chronologically subsequently. This means, for example, up to a parking position out of which additional backward travel constitutes a greater potential hazard than this comparatively safe parking position. In such a situation, control of the ego vehicle may again be given to the vehicle driver.—The backward travel may of course also be initiated if no rear evasion area has (yet) been ascertained. This evasion area may be detected only during the backward travel. The carrying out of the method initially involves a reduction of a relative speed for a potential collision as quickly as possible.

According to the present invention, the intervention method may be used in a driver assistance system of a vehicle for increasing traffic safety. The computer program according to the present invention has program code arrangement which are configured to carry out an intervention method according to the present invention if the program code arrangement run on a processing device and/or are stored on a computer-readable data medium.—The computing unit according to the present invention or the processing device, which may be the control unit or the control device, is configured in such a way that, as a result, an intervention method according to the present invention is able to be carried out and/or a computer program according to the present invention is processable.

The safety device according to the present invention or the safety system according to the present invention for a vehicle, in particular a driver assistance system for a motor vehicle, is configured in such a way that, as a result, an intervention method according to the present invention for carrying out backward travel in the event of wrong-way travel is processable. Furthermore, the safety device or the safety system may have a computer program product according to the present invention and/or a computing unit according to the present invention or a processing device according to the present invention. Such a safety device in a driver assistance system may, for example, be implemented in a wrong-way travel assistant.

An automated intervention into the ego vehicle, i.e., the processing of the intervention method according to the present invention, may be triggered automatically by the safety device or the safety system itself when the wrong-way travel of the ego vehicle is detected. A triggering or a complete carrying out of the intervention method may also be provided and/or indicated to the vehicle driver of the ego vehicle by the safety device or the safety system. Furthermore, the intervention method may be configured in such a way that the complete carrying out of the automatic intervention method may or must be confirmed by the vehicle driver.—During the carrying out of the intervention method, the vehicle driver may be informed audibly, visually, and/or haptically about the automatically proceeding steps and/or a step to be carried out by him/her chronologically subsequently.

According to the present invention, an existing method for the detection of wrong-way travel of an ego vehicle may be enhanced and thus made safer via the method according to the present invention for the automatic intervention into an ego vehicle. The intervention method according to the present invention may be integrated into an existing wrong-way travel assistant or cooperate with a relevant method in order to increase its efficiency. The intervention method according to the present invention is able to operate safely and reliably and is cost-effective to implement, since the intervention method is implementable using a sensor system and actuator system which are already installed in a motor vehicle.

The advantage of the automatic or automated backward travel according to the present invention into a safer position as opposed to sheer emergency braking of the ego vehicle is that a state of the ego vehicle, possibly into a position in which there are options for action by its vehicle driver, is achieved, or at the very least, results in a comparatively substantial reduction of a relative speed with respect to a party potentially involved in an accident.—In the event of emergency braking, only automatic braking is applied to the ego vehicle (full braking). The vehicle's driver is passive and in shock, and in the final state, is situated head-on in the oncoming traffic. The vehicle driver experiences a life-threatening feeling of helplessness. Due to this helplessness and the extreme stress situation, the vehicle driver may perform erroneous actions and/or short-cut reactions such as dodging into unidentified oncoming traffic or exiting into the oncoming traffic. All of this may be safely avoided according to the present invention.

The present invention is described in greater detail below based on exemplary embodiments with reference to the attached drawing.

### BRIEF DESCRIPTION OF THE DRAWING

The Figure shows a schematic top view of two roadways of a road which are separated from each other, each having three lanes, in a left lane of the right roadway in which a vehicle of a wrong-way driver (top) carries out a method according to the present invention for the automatic intervention when it is traveling erroneously, in particular when it is traveling the wrong way (intervention method).

### DETAILED DESCRIPTION

Map-based navigation, usually GPS in connection with electronic map information, forms a basis for an instantaneous position determination of a traveling or standing motor vehicle 20, 30, additional information being integrated into the map information. Furthermore, motor vehicle 20, 30 has sensor-based information or another type of information, for example, a surroundings detection (surroundings sensor system), a detection of a road category (road class), a traffic sign identification, etc. This information is available to a safety device or a safety system of an ego vehicle 20 under consideration here, in which the safety device or the safety system may be a driver assistance system for ego motor vehicle 20.

One object of the present invention is an automated conveyance 22 of ego vehicle 20, i.e., independently by ego vehicle 20, into a position which is safer for a vehicle driver of ego vehicle 20, for example, to a forward evasion area (not shown) or a rear evasion area 14 relative to ego vehicle 20.—If a forward exit of ego vehicle 20 into a safer position in the forward evasion area is not possible, according to the present invention, backward travel 22 of ego vehicle 20 may be initiated through braking, in particular, full braking, and chronologically subsequent negative acceleration, and an accident may possibly avoided, or a difference or relative speed iv for an accident may be minimized, and thus an accident severity may be reduced.

For this purpose, the safety device or the safety system of ego vehicle 20 may positively detect or identify the following steps: a) a category (definition) of a road 10, 12 having relevance for wrong-way travel, b) a traveling motion of ego vehicle 20 in a wrong direction in a lane 12 of road 10, or on road 10, and c) the forward evasion area and/or rear evasion area 14. Step c) is optional; the forward evasion area should be identified only for a forward exit of ego vehicle 20. Steps a) and b) form the basis for an automated intervention into a vehicle guidance of ego vehicle 20, which may be while ignoring interventions by the vehicle driver of ego vehicle 20.

Thus, if steps a) and b) are positive, control over vehicle 20 may be completely taken away from the vehicle driver of ego vehicle 20, which may be for the duration of the intervention method according to the present invention.—Steps a) and b) may be carried out, for example, based on the surroundings sensor system, an enhanced sensor system (video data, radar data, and/or data fusion) using a navigation (GPS), a car-to-X communication, possibly using cloud data, and/or an observation sensor system of the occupants. Furthermore, steps a) and b) may be carried out via an identification of traffic signs and other features for detecting the road category.

According to the present invention, in a step d), a situation evaluation for initiating the automated intervention into ego vehicle 20 may be carried out. If a choice is possible, the intervention may be selected which has the lowest hazard potential. Thus, for example, a navigation device analyzes a distance to the nearest forward evasion area and/or to the nearest rear evasion area 14, and/or the video sensor system, the radar sensor system, and/or the navigation (in SDF) analyze the forward evasion area and/or the rear evasion area 14 for a forward exit and/or backward travel 22 of ego vehicle 20. The intervention having the lowest hazard potential is selected.

If a forward exit is possible having lower risk than backward travel 22 of ego vehicle 20, a forward exit to the forward evasion area is carried out in an automated or partially automated manner. If a hazard reduction is not possible via a forward exit, according to the present invention, the automated backward travel 22 is initiated, possibly by the vehicle driver of ego vehicle 20. Simple automated braking, in particular, full braking, is initially carried out, while simultaneously minimizing a result of a head-on collision, for example, an exit of ego vehicle 20 from a driving path, for example, at a guard rail.

If oncoming traffic is involved, an identification is carried out of a travel trajectory of a potential party involved in an accident having a high and/or highest probability of an accident, the ego vehicle 20 carrying out an automated evasive maneuver via its safety device or its safety system. Here, an evasive maneuver of ego vehicle 20 is to be understood in particular as a lane change, two lane changes essentially in succession in the same or opposite directions, an evasion of any kind whatsoever with respect to an obstacle, in particular, another vehicle, an escape turn, etc. An automated evasive maneuver may be carried out chronologically during or before backward travel 22 or chronologically during or before the forward exit.

Chronologically subsequently, the automated backward travel 22 of ego vehicle 20 is carried out, for example, with lane change(s), to an emergency lane 14 or to a safe route 14 (rearward evasion area). Chronologically subsequently, additional backward travel 14 may be carried out up to a safe or a safest parking position; for example, up to a position out of which additional backward travel 22 of ego vehicle 20 constitutes a higher potential hazard for ego vehicle 20 and/or other road users than this parking position.

According to the present invention, during the method, a condition of the vehicle driver of ego vehicle 20 may be evaluated and included in the intervention method according to the present invention. This may, for example, be carried out based on information from the vehicle driver for the automated intervention. Furthermore, subordinate devices and road users, in particular other vehicles 30 located in the vicinity, may be informed about the intervention or the planned or imminent intervention. In addition, in the event of detection or identification by the safety device or the safety system, steps a) and b) may be replaced by step b) or implemented in step b).

Backward travel 22 according to the present invention reduces the relative speed Δv for a collision and thus quadratically reduces an intrusion energy. Automated backward travel 22 generally makes this possible, since a wrong-way driver is under extreme stress in a situation in which there are oncoming vehicles 30. A natural human flight reflex blocks looking backward and creates a “forward flight reflex.” In addition, an independent backward driver is able to reach an emergency lane 14 only if he/she, once in passing lane 12, changes lanes 12. However, this is possible only if the driver simultaneously looks forward again in the direction of his/her ego vehicle 20. Thus, an additional shifting of the gaze takes place, which is extremely overwhelming. Backward travel 22 according to the present invention makes possible a movement to emergency lane 14 without a manual turn, which creates an extreme hazard situation (lateral crash).

What is claimed is:

1. A method for providing an automatic intervention into an ego vehicle, via a safety device or a safety system of the ego vehicle, the method comprising:
initially detecting erroneous travel or wrong-way travel of the ego vehicle on the road; and
performing automated backward travel by the ego vehicle chronologically after the erroneous or wrong-way travel is detected.

2. The method of claim 1, further comprising:
performing, chronologically before carrying out the automated backward travel, a situation evaluation for the ego vehicle by the safety device or the safety system; and
selecting an intervention having a low hazard potential.

3. The method of claim 1, wherein the automated backward travel by the ego vehicle is performed only if a forward exit and/or an escape turn of the ego vehicle having a lower hazard potential than the automated backward travel is not possible.

4. The method of claim 1, wherein an actual intervention into the ego vehicle assumes identification of a road category of the road which is traveled on has relevance to wrong-way travel, and a detection of the wrong-way travel of the ego vehicle on this road.

5. The method of claim 1, wherein the safety device or the safety system of the ego vehicle determines a trajectory or an evasion trajectory to at least one of an evasion area, an open area, and an escape point for the backward travel.

6. The method of claim 1, wherein the intervention includes at least one of a brake intervention, an acceleration intervention, and a steering intervention into the ego vehicle, the ego vehicle is brake-able in an automated manner, initiating and carrying out the backward travel in an automated manner, and if necessary, when braking and/or during the backward travel, carrying out a lane change in an automated manner and/or an evasive maneuver in an automated manner.

7. The method of claim 1, wherein the automated backward travel is at least one lane change to the evasion area, in particular, to an emergency lane or a safe route, and wherein additional automated backward travel up to a safe position is subsequently performable chronologically.

8. The method of claim 1, wherein:
the intervention method is performed only if a corresponding road category is ascertained and/or detected;
the road category of the road and the wrong-way travel of the ego vehicle on the road are ascertained by the safety device or the safety system of the ego vehicle;
a process for detecting the wrong-way travel of the ego vehicle is based on information of a map-based navigation, in particular, based on GPS and map information, on a surroundings sensor system, an enhanced sensor system, and/or a traffic sign identification;
in the event of the detection of the wrong-way travel of the ego vehicle, the method is automatically triggered, and/or a triggering of the backward travel is provided to the vehicle driver and must be confirmed by the vehicle driver;
the backward travel is performed essentially at a maximum speed, the hazard warning lights of the ego vehicle being activatable; and/or
chronologically after the backward travel, a request for assuming control of the vehicle and/or accelerating the ego vehicle is issued to the vehicle driver of the ego vehicle.

9. A computer readable medium having a computer program, which is executable by a processor, comprising:
a program code arrangement having program code for providing an automatic intervention into an ego vehicle, via a safety device or a safety system of the ego vehicle, by performing the following:
initially detecting erroneous travel or wrong-way travel of the ego vehicle on the road; and
performing automated backward travel by the ego vehicle chronologically after the erroneous or wrong-way travel is detected.

10. A control device of a vehicle, comprising:
a control unit for providing an automatic intervention into an ego vehicle, via a safety device or a safety system of the ego vehicle, by performing the following:
initially detecting erroneous travel or wrong-way travel of the ego vehicle on the road; and
performing automated backward travel by the ego vehicle chronologically after the erroneous or wrong-way travel is detected.

11. A safety system for a vehicle, comprising:
a driver assistance system for a motor vehicle;
wherein the safety system is configured for providing an automatic intervention into an ego vehicle, via a safety device or a safety system of the ego vehicle, by performing the following:
initially detecting erroneous travel or wrong-way travel of the ego vehicle on the road; and
performing automated backward travel by the ego vehicle chronologically after the erroneous or wrong-way travel is detected.
